(19) United States
(12) Patent Application Publication
(10) Pub. No.: US 2022/0114446 A1
(43) Pub. Date: Apr. 14, 2022

(54) METHOD, DEVICE AND COMPUTER PROGRAM FOR CREATING A NEURAL NETWORK

(71) Applicant: Robert Bosch GmbH, Stuttgart (DE)

(72) Inventors: Arber Zela, Freiburg (DE); Frank Hutter, Freiburg Im Breisgau (DE); Thomas Brox, Freiburg (DE); Tonmoy Saikia, Freiburg (DE); Yassine Marrakchi, Freiburg (DE)

(21) Appl. No.: 17/421,886

(22) PCT Filed: Apr. 8, 2020
(86) PCT No.: PCT/EP2020/060012

§ 371 Date: Jul. 9, 2021

(30) Foreign Application Priority Data
Apr. 18, 2019 (DE) 10 2019 205 729.2
May 8, 2019 (DE) 10 2019 206 620.8

(51) Int. Cl. G06N 3/08

(52) U.S. Cl. CPC G06N 3/08

(57) ABSTRACT

A method for creating a neural network, which includes an encoder that is connected to a decoder. The optimization method DARTS is used, a further cell type being added to the cell types of DARTS. A computer program and a device for carrying out the method, and a machine-readable memory element, on which the computer program is stored, are also described.

### FIELD

The present invention relates to a method for optimizing an architecture and a parameterization of a neural network. The present invention also relates to a device and to a computer program, each of which is configured to carry out the method.

### BACKGROUND INFORMATION

Liu, Hanxiao, Karen Simonyan and Yiming Yang: “DARTS: Differentiable architecture search.” arXiv preprint arXiv:1806.09055 (2018) describe a method for optimizing an architecture of a neural network with the aid of a gradient descent method.

Falkner, Stefan, Aaron Klein and Frank Hutter: “BOHB: Robust and efficient hyperparameter optimization at scale.” arXiv preprint arXiv:1807.01774 (2018) describe a method for optimizing hyperparameters of a neural network with the aid of a combination of a Bayesian optimization and a hyperband optimization algorithm.

Olaf Ronneberger, Philipp Fischer and Thomas Brox: “U-Net: Convolutional Networks for Biomedical Image Segmentation.” arXiv preprint arXiv: 1505.04597 (2018) describe an architecture of a neural network including convolutional layers and skip connections, which is referred to as a U-net.

### SUMMARY

It is presently extremely difficult if not impossible to optimize an architecture of neural networks that include an encoder and a decoder. The conventional methods are unable to carry out this complex optimization within a reasonable period of time using only a graphic card (GPU). The architecture of these neural networks is therefore either designed by experts or only small neural networks are optimized in an automated manner. It is desirable, however, to also optimize architectures of more complex neural networks that include encoders and decoders, so that these are also able to carry out more sophisticated tasks such as, for example, a depth determination of objects from two stereo images or a semantic segmentation of images. It is also not possible to optimize an architecture of the aforementioned U-nets.

The method including the features of an example embodiment of the present invention has the advantage over the related art that this method makes it possible for the first time to optimize the architecture of complex neural networks including encoders and decoders and, if necessary, including skip connections in a computer resource-efficient manner.

### SUMMARY

In a first aspect of the present invention, a, in particular, computer-implemented method for creating a neural network, which includes an encoder that is connected to a decoder is provided.

In accordance with an example embodiment of the present invention, the method includes, among others, the following steps: providing in each case a resolution of input variables and output variables of the encoder and the decoder. This is followed by a provision of different cell types. Each cell type includes a plurality of nodes which are connected according to a predefinable sequence starting at at least one input node and ending at an output node. Each node is connected to all of its preceding nodes with the aid of directed edges. Directed edges may be understood to mean that these edges process pieces of information in only one direction. Each edge is assigned a plurality of parameterizable operations and all operations are assigned one first variable each. The edges are configured to process an intermediate variable of the preceding node in each case with the aid of each of the operations assigned to it and, as a function of the first variable assigned to the respective operation, to add together in a weighted manner and provide to the following connected node as the intermediate variable thereof. A first cell type (reduction cell) is configured to reduce the resolution of its output variable relative to the resolution of its input variable. A second cell type (upsampling cell) is configured to increase the resolution of its output variable relative to the resolution of its input variable. This is followed by a concatenation of a plurality of cells of the different cell types, so that the provided resolutions are achieved. This is followed by a provision of training data, which include the training input variables and training output variables assigned in each case to the training input variables. This is followed by an alternating adaptation of the first variables and a parameterization of the parameterizable operations. The adaption takes place in such a way that a difference between output variables, which are ascertained along the concatenated cells with the aid of a propagation of the training input variables, and the training output variables, is optimized, in particular, until a predefinable criterion is met. This is followed by a selection of one each of the operations of the edges as a function of the adapted first variables. This is followed by the creation of the neural network as a function of the concatenated cells and of the selected operations.

An encoder may be understood to mean a first predefinable sequence of layers of the neural network, the sequence being configured to ascertain the output variable of the encoder as a function of the input variable of the encoder, the resolution of the output variable being lower than the resolution of the input variable.

A decoder may be understood to mean a second sequence of layers of the neural network, which are connected to the first sequence of layers. The second sequence of layers is configured to ascertain the output variable of the decoder as a function of the input variable of the decoder, i.e., of the output variable of the encoder, the resolution of the output variable of the decoder being higher than the resolution of the input variable of the decoder.

A resolution may be understood to mean a spatial resolution of the respective input variable or the intermediate variable. The resolution preferably characterizes a number of data points, which include the input variable or the intermediate variable. If the input variable is at least one image, then the resolution may be provided by a number of pixels.

An alternating adaptation may be understood to mean that the parameterization and the first variables are optimized in succession, in particular, with one or with multiple iterations.

A difference may be understood to mean a mathematical distance measure, which characterizes a difference between the ascertained output variables and the training output variables, in particular, as a function of the parameterization and of the first variables. The difference is preferably ascertained with the aid of a loss function.

A propagation may be understood to mean that an input variable is processed successively by the cells.

It is possible that, in addition to the resolution, further pieces of information are provided such as, for example, a predefinable arrangement of layers of the neural network or a design of the neural network.

A cell may be understood to mean a directed non-cyclical graph including a predefinable number of nodes.

More than one input node of every cell type is also possible. The advantage in this case is that neural networks including a multitude of skip connections may therefore also be optimized.

An advantage of the method of the first aspect is that the second cell type makes it possible to optimize neural networks including encoders and decoders in a scalable manner.

In accordance with an example embodiment of the present invention, it is provided that the neural network is also created as a function of the adapted parameterization of the selected operations.

The intermediate variable of the nodes may be a sum of all provided intermediate variables of the respective node, in particular, of the edges that are connected to this node. The output variable of the output node may contain each provided intermediate variable of the nodes that are connected to the output node. All intermediate variables of the nodes that are connected to the output nodes are preferably combined to form the output variable of the output node.

In accordance with an example embodiment of the present invention, it is further provided that the second cell type is further configured to interpolate the input variable of the input node, in particular, with the aid of a parameterizable operation such as, for example, a transposed convolution. Interpolate may be understood in the following to mean that the, in particular, spatial resolution increases, for example, by a factor of 2.

The reduction of the resolution of the second cell type may be achieved by removing pieces of information from the intermediate variables, preferably with the aid of a rejection operation (max-average-pooling).

In accordance with an example embodiment of the present invention, it is further provided that the neural network includes at least one skip connection, which forwards an intermediate variable of the encoder to the decoder. The second cell type additionally includes a third input node and the second cell type is further configured to interpolate an input variable of the third input node, in particular, with the aid of a parameterizable operation such as, for example, a bilinear interpolation.

The resolution of the output variable, which is used as the input variable of the third input node, preferably has the same resolution as the input variable of the cell of the third cell type.

In accordance with an example embodiment of the present invention, it is further provided that every first variable is a function of the further first variable of the further operation of the respective edge, in particular, relaxed with the aid of a softmax function. When selecting the operations, the operations of the edges to which the largest first variable is assigned are preferably selected in each case.

The advantage in this case is that now optimization may take place via the relaxed first variable with the aid of a gradient descent method.

In accordance with an example embodiment of the present invention, it is further provided that when adapting the first variable and the parameterization, the difference is optimized with the aid of a gradient descent method and the parameterization is optimized with the aid of the gradient descent method. A learning rate of the gradient descent method for optimizing the parameterization is advantageously ascertained with the aid of a probabilistic optimization (such as, for example, BOHB). Then, when the neural network has been created, the parameterization may be newly adapted, in particular, optimized so that the difference becomes minimal.

The gradient descent method has the advantage that it is scalable. The advantage of BOHB is that BOHB may be carried out in a parallelized manner.

In accordance with an example embodiment of the present invention, it is further provided that a plurality of identical neural networks are created, which are then connected in series. The NN connected in series are then collectively optimized with respect to the parameterization.

In accordance with an example embodiment of the present invention, it is further provided that the neural network receives two stereo images of two cameras and that the neural network is configured to ascertain as a function of the stereo images a depth estimation of the mapped objects of the images. The neural network processes the stereo images with the aid of one further encoder or filter each, followed by a correlation layer, before the processing with the aid of the encoder and the decoder.

The cameras are able to detect the same scene from different perspectives.

In accordance with an example embodiment of the present invention, it is advantageous if the neural network is a U-net or an autoencoder or a neural network, which is configured to carry out a semantic segmentation or a depth estimation.

In one further aspect of the present invention, it is provided that the created neural network of the first aspect is used for a technical system.

In accordance with an example embodiment of the present invention, the technical system includes a detection unit (for example, a camera), which is connected to the neural network and provides the neural network a detected variable (for example, a camera image) as an input variable. An actuator of the technical system is activated as a function of an ascertained output variable of the neural network. Alternatively, a control variable may be ascertained as a function of the output variable of the technical system. The actuator may then be activated as a function of the control variable.

The technical system may, for example, be an at least semi-autonomous machine, an at least semi-autonomous vehicle, a robot, a tool, a factory machine or a flying object such as a drone.

In one further aspect of the present invention, a computer program is provided. The computer program is configured to carry out one of the above-mentioned methods. The computer program includes instructions, which prompt a computer to carry out one of these aforementioned methods including all its steps when the computer program runs on the computer. A machine-readable memory module is also provided, on which the computer program is stored. In addition, a device is provided, which is configured to carry out one of the methods of the first aspect.

Exemplary embodiments of the above-mentioned aspects are represented in the figures and explained in greater detail in the description below.

### BRIEF DESCRIPTION OF THE DRAWINGS

FIG. 1 schematically shows a representation of a conventional cell for DARTS and of a newly provided upsampling cell.

FIG. 2 schematically shows a representation of a flowchart for optimizing an architecture and a parameterization of a neural network including an encoder and a decoder, in accordance with an example embodiment of the present invention.

FIG. 3 schematically shows a representation of an at least semi-autonomous robot, in accordance with an example embodiment of the present invention.

FIG. 4 schematically shows a representation of a device for optimizing a neural network, in accordance with an example embodiment of the present invention.

### DETAILED DESCRIPTION OF EXAMPLE EMBODIMENTS

A neural network including an encoder and a decoder is characterized in that an input variable such as, for example, a high-resolution image, for example, 940×512 pixels, is mapped during propagation by the neural network onto an intermediate variable with the aid of the coder, whose resolution is lower than the resolution of the input variable. The resolution of this intermediate variable may be 32×32 pixels in the case of the U-net, for example. This intermediate variable is subsequently propagated further through the decoder of the neural network until the output variable is present. The output variable may have the same, a higher or a lower resolution than the input variable, however, the resolution of the output variable is higher than the resolution of the intermediate variable. The resolution of the output variable of the U-net may be 388×388 pixels.

The encoder may be designed in the form of multiple serially connected “downsampling” layers of the neural network, which are characterized in that these reduce the resolution of their input variable. The reduction of the resolution of the input variable may be predefined by a “downsampling” factor. For example, the “downsampling” layers may each include multiple 3×3 filters, whose intermediate variables are processed by an activation function and a max-pooling with stride 2 is subsequently used. Layers may also be interconnected after the individual “downsampling” layers, which leave the resolution of their input variable unchanged, for example, fully connected layers.

The decoder may be constructed of multiple serially connected “upsampling” layers of the neural network. The number of “upsampling” layers may be a function of the “downsampling” factor. The “upsampling” layers may first carry out an upsampling of their input variable, followed by one or multiple convolutions including 2×2 or 3×3 filters.

The neural network, which includes the encoder and the decoder, may also include skip connections, each of which connects one of the “downsampling” layers to one of the “upsampling” layers. If the resolution of the provided input variable through the skip connection does not correspond to the resolution of the input variable of the “upsampling” layer, the provided input variable through the skip connection may be adapted with the aid of the bilinear interpolation to the resolution of the input variable of the “upsampling” layer.

The neural networks including this described design, i.e., including an encoder and a decoder, are not optimizable using the present-day architecture optimization methods, for example, the DARTS method is available in the related art. This will be briefly explained below.

An architecture optimization using DARTS is desirable, however, since DARTS has the advantage that this method uses a gradient descent method and is therefore scalable. Furthermore, both the architecture as well as a parameterization of the neural network may be optimized in an alternating manner with the aid of DARTS. Parameterization may be understood to mean all parameters of the network, as a function of which the neural network ascertains its output variable, in particular, in the case of an inference. The parameterization of the neural network preferably includes weights of the neural network and filter coefficients of the filters of the neural network.

In the case of DARTS, the architecture of the neural network is represented with a plurality of cells, which are connected to one another according to a predefined sequence. These connected cells describe the so-called search network, via which optimization is to take place. A cell is a directed non-cyclical graph, which includes a plurality of N different nodes. The cell has at least one input node, the cells preferably have two or more input nodes. The cells further include multiple intermediate nodes and an output node. Each of the nodes represents an intermediate variable x(i), in other words, an activation map, of the neural network and each of the edges (i,j) represents an operation o^{(i,j)}, in particular, a transformation, which maps intermediate variable x(i) of node i onto intermediate variable x(i) of node j. All nodes are connected to all of their preceding nodes. The output node is also connected to all preceding nodes, the output variable of the output node being ascertained by a concatenation of the intermediate variables of all preceding nodes.

An intermediate result x(j) of the j-th node is ascertained as follows:

$${x}^{( j )} = {\sum }_{i < j} {o}^{( i , j )} ( {x}^{( i )} ) \qquad ( 1 )$$

with o^{(i,j)}∈O and o being the set of all possible operations.

The following possible operations are possible: skip connection, 3×3 average pooling, 3×3 max pooling, 3×3 and 5×5 convolutions (dilated separable convolutions, for example, with dilation factor 2) and a “zero” connection (zero operation), which represents a non-existing connection between the nodes.

The input nodes are each connected to an output node of a preceding cell of the search network.

DARTS uses two different types of cells. There is a normal cell, which maintains the resolution of its input variables, and there is a reduction cell, which reduces a resolution of its input variables, preferably by a factor two.

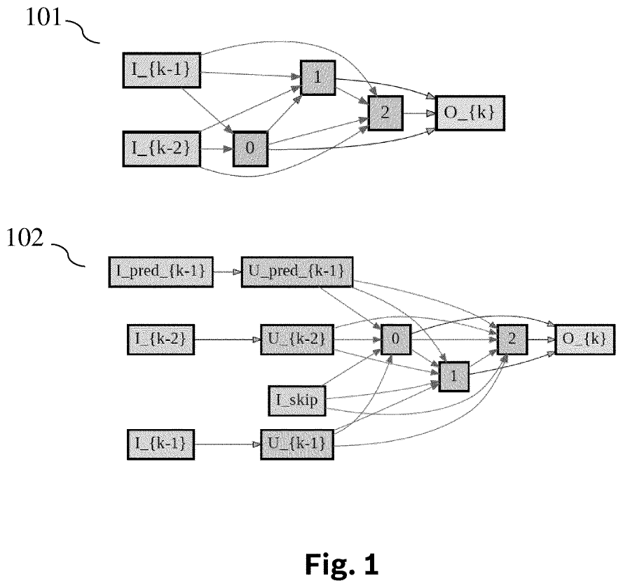

The normal cell is schematically represented in FIG. 1 above with reference numeral 101. Normal cell 101 contains, for example, 6 nodes, of which 2 input nodes (I_{k−1}, I_{k−2}), 3 intermediate nodes (0, 1, 2) and one output node (O_{k}) are present.

To be able to optimize via different operations o^{(i,j)}, in particular, with the aid of a gradient descent method, the function to be optimized must be continuous. This is achieved in DARTS with the aid of the introduction of variables α^{(i,j)}∈ [symbol] and of a relaxation of these variables α^{(i,j)}. Each operation o^{(i,j)} of edges i,j is assigned a variable α^{(i,j)}. The relaxation of variables α^{(i,j)} may be achieved with the aid of a softmax function, which is applied to all variables of possible operations O of the edge:

$${S}_{o}^{( i , j )} = \frac{exp ( {α}^{( i , j )} )}{{\sum }_{o ∈ 0} exp ( {α}^{( i , j )} )} \qquad ( 2 )$$

This results in the following equation:

$${\overline{o}}^{( i , j )} = {\sum }_{o ∈ 0} {S}_{o}^{( i , j )} o ( {x}^{( i )} ) \qquad ( 3 )$$

Equation 1 may now be rewritten with equation 3:

$${x}^{( j )} = {\sum }_{i < j} {\overline{o}}^{( i , j )} ( {x}^{( i )} ) \qquad ( 4 )$$

The optimization of the architecture may now be alternatingly carried out with the aid of a gradient descent method via variable α and via parameterization w of the neural network.

Only neural networks including an encoder may be optimized with the aid of the above described DARTS method. With the two different cell types according to DARTS, it is not possible to optimize an architecture made up of an encoder and a decoder, since no suitable cell type is available for the decoder.

Therefore, a new cell type is provided below in order to be able to also optimize architectures of neural networks including an encoder and a decoder.

For this purpose, a so-called upsampling cell is provided. The upsampling cell is schematically represented in FIG. 1 with reference numeral 102. Upsampling cell 102 differs from the other cell types 101 in that this upsampling cell 102 in this example includes, in addition to input nodes (I_{k−2}, I_{k−1}), two further input nodes (I_skip, I_pred_{k−1}) and each of the input nodes is connected to an upsampling node, which interpolates the input variable, in particular, interpolates the resolution of the respective input variable by a factor 2.

In one further exemplary embodiment, upsampling cell 102 has only one input node (I_{k−1}) and only one further input node (I_pred_{k−1}).

Two input nodes (I_{k−2}, I_{k−1}) are also connected in the search network, each to an output node of a preceding cell.

Further input node (I_pred_{k−1}) is connected in the search network to an output node of a preceding upsampling cell. Further input node (I_skip) is connected to a preceding normal cell or to a preceding reduction cell.

The interpolation of the input variables of the upsampling cell may be carried out with the aid of a transposed convolution. The interpolation of the input variable of input node (I_skip) is preferably carried out by a linear interpolation.

The intermediate nodes of the upsampling cell are handled as described above for the other cell types, in particular, the same possible operations O are used.

The output node of the upsampling cell is also connected to all preceding nodes of this cell. The results of all preceding nodes are preferably merged and subsequently processed optionally with the aid of a convolution and then output as an output variable.

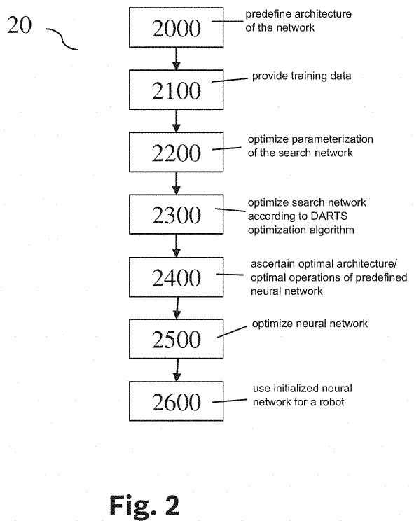

FIG. 2 schematically shows a flowchart for optimizing an architecture and a parameterization of a neural network including an encoder and a decoder

Method 20 starts with step 2000. In this step, an architecture of the network is predefined. The architecture may, for example, be predefined by the resolution of the input and output variable of the neural network, by a number of the input variables. The architecture of the neural network may also be predefined by the lowest resolution of the intermediate variables of the neural network or of a number of the layers of the neural network, etc.

In one specific embodiment of method 20, the architecture of the neural network is provided by an encoder including 6 (convolution) layers, each of which halves the resolution of its input variable and doubles the number of filters of these layers, compared to the number of filters of its preceding layer. The decoder of the neural network in this exemplary embodiment is provided by three (convolution) layers, which double in each case the resolution of their input variable.

For depth estimations using the deep neural network, a Siamese network may process the input variable of the neural network and forward to a correlation layer, which then provides, for example, its intermediate variable to the decoder.

Properties of the cell types may also be defined in step 2000, for example, that each cell type has only 3 intermediate nodes. The set of all possible operations of every edge may also be established in step 2000.

A search network is subsequently created as a function of the predefined architecture and the defined cells. For this purpose, a plurality of the 3 different cell types, normal cells, reduction cells and upsampling cells are serially arranged so that the predefinable architecture is achieved. This means, after the completion of step 2000, the search network, including the different serially arranged cells that are to be subsequently optimized in the following step, is present.

In the specific embodiment of the method, in which the neural network including the encoder, which contains 6 layers, and the decoder, which contains 3 layers, the search network may be created as follows: The encoder of the neural network is created by an arrangement of alternatingly normal cells and reduction cells, for example, 6 cells each of the two types. The decoder of the search network in this specific embodiment includes 3 cells of the upsampling cell type. It should be noted that the reduction/increase of the resolutions of the layers matches the reduction/increase of the resolutions of the reduction cells and upsampling cells.

In following step 2100, training data including training input variables and respectively assigned training output variables are provided. The training data are divided into two sets, these sets preferably each include an equal number of training input variables and respectively assigned training output variables.

Once step 2100 has been completed, optional step 2200 follows. In this step, parameterization w of the search network may be optimized in advance on the training data or on one of the two sets of the training data. For this purpose, the training input data are propagated through the search network. A loss function, which is a function of parameterization w and of variables α, is subsequently ascertained as a function of the ascertained output variables of the search network and of the respective training output variables. With the aid of a gradient descent method, for example, Stochastic Gradient Descent (SGD), it is then possible via parameterization w to optimize, in particular, minimize or maximize, the loss function. It should be noted that parameterization w need not be completely optimized. It is sufficient if the parameterization is optimized only over a plurality of iterations without the occurrence of a convergence.

Once optional step 2200 or step 2100 has been completed, step 2300 follows. In this step, the search network is optimized according to the DARTS optimization algorithm. This means, optimization takes place alternatingly via variable α and via parameterization w with the aid of a gradient descent method.

The optimization of variable α is carried out on one of the two sets of training data from step 2100. Once this optimization has been completed, the optimization of parameterization w is carried out on the second set of the training data. This alternating optimization of variable α and of the parameterization is carried out multiple times, in particular, until a predefinable abort criterion is met.

A learning rate of the gradient descent method may, for example, be optimized separately with the aid of BOHB, in order to obtain better convergence properties. Optimization of parameters using BOHB, see in this regard the document “BOHB: Robust and efficient hyperparameter optimization at scale” mentioned at the outset.

In following step 2400, an optimal architecture, in particular, optimal operations, of the predefined neural network from step 2000 is ascertained as a function of variable α. According to the DARTS method, the relaxation of variables α is carried out retrogressively for this purpose. This may be carried out, for example by selecting the strongest operation for each edge as a function of variable α:

$${max}_{o ∈ O , o \neq zero} {S}_{o}^{( i , j )} \qquad ( 5 )$$

Once the optimal operations have been ascertained in step 2400, a neural network is optimized in step 2500 according to these selected operations and the predefined architecture from step 2000. Furthermore, parameterization w, which has been optimized in step 2300, is also used for the initialization of the neural network.

It is also possible that the initialized neural network is connected multiple times in series, comparable to an AutoDispNet-CSS.

Parameterization w of the initialized neural network is subsequently repeatedly optimized in step 2500 on the provided training data. For this purpose, the training input data are propagated by the initialized neural network and the parameterization is adapted, in particular, based on step 2100, as a function of the ascertained output variables and of the training output variables.

In following optional step 2600, the initialized neural network from step 2500 is used for a robot. For example, the neural network from step 2500 may be used in order to ascertain an output variable as a function of a provided input variable, the robot subsequently being controlled with the aid of a control unit as a function of the output variable.

This ends method 20.

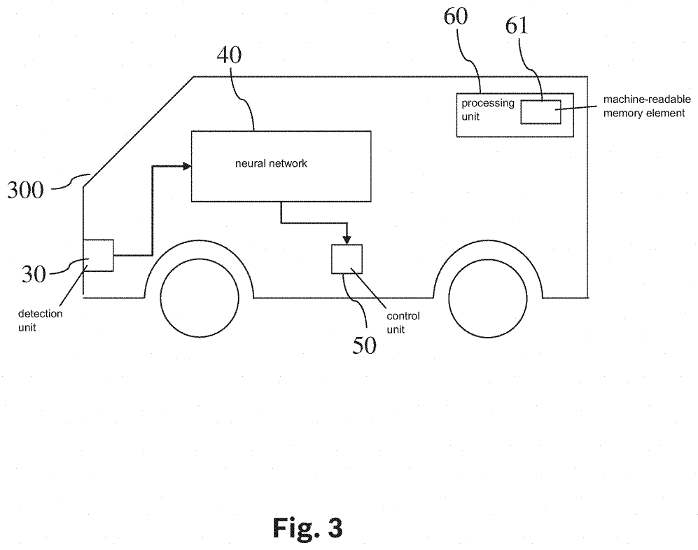

FIG. 3 schematically shows a representation of an at least semi-autonomous robot, which is provided in a first exemplary embodiment by an at least semi-autonomous vehicle 300. In one further exemplary embodiment, the at least semi-autonomous robot may be a service robot, an assembly robot or a stationary production robot, alternatively an autonomous flying object, such as a drone.

The at least semi-autonomous vehicle 300 may include a detection unit 30. Detection unit 30 may, for example, be a camera, which detects the surroundings of vehicle 300. Detection unit 30 may be connected to neural network 40, obtained according to step 2600. Neural network 40 ascertains an output variable as a function of the provided input variable, for example, provided by detection unit 30, and as a function of a plurality of parameters of neural network 40. The output variable may be forwarded to a control unit 50.

Control unit 50 controls an actuator as a function of the output variable of neural network 40, preferably controls the actuator in such a way that vehicle 300 carries out a collision-free maneuver. In the first exemplary embodiment, the actuator may be a motor or a braking system of vehicle 300. In one further exemplary embodiment, the semi-autonomous robot may be a tool, a factory machine or a production robot. A material of a workpiece may be classified with the aid of neural network 40. The actuator in this case may, for example, be a motor, which drives a grinding head.

Vehicle 300, in particular, the semi-autonomous robot, further includes a processing unit 60 and a machine-readable memory element 61. A computer program may be stored on memory element 61, which includes commands which, when the commands are carried out on processing unit 60, result in processing unit 60 carrying out the method including all its steps, or only step 2600, according to FIG. 2. Alternatively, neural network 40 may be stored on memory element 61 and the processing unit carries out the calculations of neural network 40.

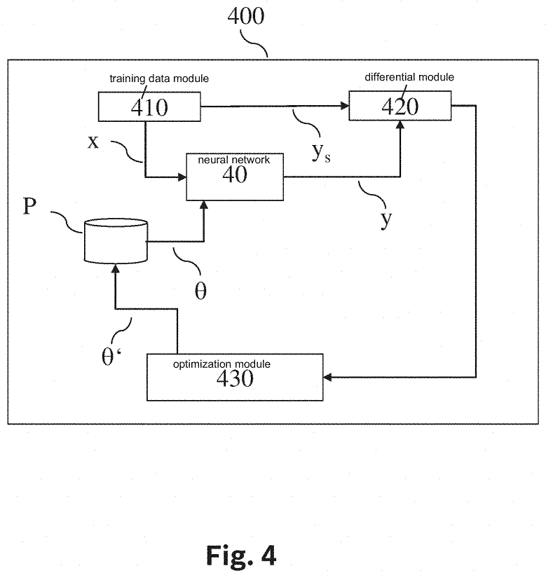

FIG. 4 schematically shows a representation of a device 400 for optimizing, in particular, training neural network 40, in particular, for carrying out the steps for optimizing neural network 40. Device 400 includes a training data module 410 and a differential module 420. Differential module 420 ascertains a difference, in particular, with the aid of the loss function, as a function of training output variables yₛ and of ascertained output variables y of neural network 40. Training data module 410 contains the training data. The training data appropriately include a plurality of training input variables, each of which are labeled. During optimization, optimization module 430 ascertains a change θ′ of parameterization w or of variable α as a function of the ascertained difference of differential module 420. An adaptation is then made in a memory P, in which parameterization w or variables α are stored, as a function of change θ′.

1-13. (canceled)

14. A method for an automated creation of a neural network which includes an encoder that is connected to a decoder, the method comprising the following steps:
providing respectively a resolution of input variables and output variables of the encoder and of the decoder;
providing different cell types, each cell type of the cell types including a plurality of nodes connected according to a predefinable sequence starting at at least one input node and ending at an output node, each node of the plurality of nodes being connected to all its preceding nodes using directed edges, each edge of the edges being assigned a plurality of parameterizable operations and all operations being assigned one first variable each, the edges being configured to process an intermediate variable of a preceding node in each case using each of the operations assigned to it and as a function of the first variable assigned to the respective operation, to add together in a weighted manner and provide to a following connected node as the intermediate variable thereof, a first cell type of the cell types being configured to reduce the resolution of its output variable relative to the resolution of its input variable, a second cell type of the cell types being configured to increase the resolution of its output variable relative to the resolution of its input variable;
concatenating a plurality of cells of the different cell types, so that provided resolutions are achieved, the input nodes of the cells each being connected to the output nodes of an immediately preceding cell;
providing training data, which include the training input variables and training output variables assigned in each case to the training input variables;
alternatingly adapting the first variables and a parameterization of the parameterized operations, the adaptation taking place in such a way that a difference between output variables which are ascertained using a propagation of the training input variables along the concatenated cells and the training output variables is optimized;
selecting in each case one of the operations of the edges as a function of the adapted first variables; and
creating the neural network as a function of the concatenated cells and of the selected operations.

15. The method as recited in claim 14, wherein the second cell type is further configured to interpolate the input variable of the input node using a parameterizable operation.

16. The method as recited in claim 14, wherein the second cell type additionally includes a second input node, the second cell type further being configured to interpolate an input variable of the second input node using of a parameterizable operation, and wherein during concatenation of the plurality of cells, the second input nodes of the cells of the second cell type being connected to an output of a preceding cell of the second cell type.

17. The method as recited in claim 16, wherein the neural network includes at least one skip connection, which forwards an intermediate variable of the encoder to the decoder, the second cell type also including a third input node, and the second cell type further being configured to interpolate an input variable of the third input node using a parameterizable operation, and during concatenation of the plurality of cells, the third input node being connected to the output node of one of the cells of the first type.

18. The method as recited in claim 14, wherein a third cell type of the cell types is configured to process its input variable in such a way that a resolution of its input variable corresponds to a resolution of its output variable, and wherein during concatenation of the plurality of cells, a cell of the third cell type being inserted at least between one of the cells of the first cell type or of the second cell type.

19. The method as recited in claim 14, wherein the training data are divided into a first set of training data and into a second set of training data, the parameterization being optimized via the first set of the training data and the first variables being optimized via the second set of the training data.

20. The method as recited in claim 14, wherein each of the first variables is a function of a further first variable of a further operation of the respective edge, and is relaxed with the aid of a softmax function, and wherein during selection of the operations, the operations of the edges to which a largest first variable is assigned being selected in each case.

21. The method as recited in claim 20, wherein during adaptation of the first variables and of the parameterization, the difference is optimized using a gradient descent method and the parameterization is optimized using the gradient descent method, a learning rate of the gradient descent method for optimizing the parameterization is ascertained using a probabilistic optimization, when the neural network has been created, the parameterization then being newly adapted.

22. The method as recited in claim 14, wherein a first factor is predefined for the first cell type, which characterizes by how much the resolution of its output variable is reduced, and a second factor being predefined for the second cell type, which characterizes by how much the resolution of its output variable is increased.

23. The method as recited in claim 14, wherein the neural network receives two stereo images of two cameras and the neural network is configured to ascertain as a function of the stereo images a depth estimation of mapped objects of the images, the stereo images being processed by the neural network using a further encoder, followed by a correlation layer, and only then being processed using the encoder and the decoder.

24. A non-transitory machine-readable memory element on which is stored a computer program for an automated creation of a neural network which includes an encoder that is connected to a decoder, the computer program, when executed by a computer, causing the computer to perform the following steps:
providing respectively a resolution of input variables and output variables of the encoder and of the decoder;
providing different cell types, each cell type of the cell types including a plurality of nodes connected according to a predefinable sequence starting at at least one input node and ending at an output node, each node of the plurality of nodes being connected to all its preceding nodes using directed edges, each edge of the edges being assigned a plurality of parameterizable operations and all operations being assigned one first variable each, the edges being configured to process an intermediate variable of the preceding node in each case using each of the operations assigned to it and as a function of the first variable assigned to the respective operation, to add together in a weighted manner and provide to a following connected node as the intermediate variable thereof, a first cell type of the cell types being configured to reduce the resolution of its output variable relative to the resolution of its input variable, a second cell type of the cell types being configured to increase the resolution of its output variable relative to the resolution of its input variable;
concatenating a plurality of cells of the different cell types, so that provided resolutions are achieved, the input nodes of the cells each being connected to the output nodes of an immediately preceding cell;
providing training data, which include the training input variables and training output variables assigned in each case to the training input variables;
alternatingly adapting the first variables and a parameterization of the parameterized operations, the adaptation taking place in such a way that a difference between output variables which are ascertained using a propagation of the training input variables along the concatenated cells and the training output variables is optimized;
selecting in each case one of the operations of the edges as a function of the adapted first variables; and
creating the neural network as a function of the concatenated cells and of the selected operations.

25. A device configured for an automated creation of a neural network which includes an encoder that is connected to a decoder, the device configured to:
provide respectively a resolution of input variables and output variables of the encoder and of the decoder;
provide different cell types, each cell type of the cell types including a plurality of nodes connected according to a predefinable sequence starting at at least one input node and ending at an output node, each node of the plurality of nodes being connected to all its preceding nodes using directed edges, each edge of the edges being assigned a plurality of parameterizable operations and all operations being assigned one first variable each, the edges being configured to process an intermediate variable of the preceding node in each case using each of the operations assigned to it and as a function of the first variable assigned to the respective operation, to add together in a weighted manner and provide to a following connected node as the intermediate variable thereof, a first cell type of the cell types being configured to reduce the resolution of its output variable relative to the resolution of its input variable, a second cell type of the cell types being configured to increase the resolution of its output variable relative to the resolution of its input variable;
concatenate a plurality of cells of the different cell types, so that provided resolutions are achieved, the input nodes of the cells each being connected to the output nodes of an immediately preceding cell;
provide training data, which include the training input variables and training output variables assigned in each case to the training input variables;
alternatingly adapt the first variables and a parameterization of the parameterized operations, the adaptation taking place in such a way that a difference between output variables which are ascertained using a propagation of the training input variables along the concatenated cells and the training output variables is optimized;
select in each case one of the operations of the edges as a function of the adapted first variables; and
create the neural network as a function of the concatenated cells and of the selected operations.
